(19) United States
(12) Patent Application Publication
(10) Pub. No.: US 2010/0265183 A1
(43) Pub. Date: Oct. 21, 2010

(54) STATE CHANGES FOR AN ADAPTIVE DEVICE

(75) Inventors: Scott M. Mail, Seattle, WA (US); Hakon Strande, Redmond, WA (US); Daniel M. Sangster, Bellevue, WA (US); Vincent Ball, Kirkland, WA (US); Yuan-Chou Chung, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/817,048

(22) Filed: Jun. 16, 2010

Related U.S. Application Data
(63) Continuation-in-part of application No. 12/426,848, filed on Apr. 20, 2009.

(51) Int. Cl. G06F 3/02; G06F 3/041; G06F 13/12

(52) U.S. Cl. 345/168; 345/173; 710/67

(57) ABSTRACT

Various embodiments of systems and method to implement a state change for an adaptive device are provided. In one example, a method is disclosed that includes receiving a system state input indicating a change in a system state of a computing device, changing adaptive device data in response to the system state input to form changed adaptive device data, the adaptive device data and the changed adaptive device data each including one or more of image data and adaptive device mapping data, and adjusting an adaptive device display state using the changed adaptive device data, wherein adjusting the adaptive device display state includes one or more of displaying the image data on the keyboard display and adjusting an adaptive device mapping state according to the adaptive device mapping data.

### CROSS REFERENCE TO RELATED APPLICATIONS

This application claims priority to and is a continuation-in-part of U.S. patent application Ser. No. 12/426,848, filed Apr. 20, 2009 and entitled CONTEXT-BASED STATE CHANGE FOR AN ADAPTIVE INPUT DEVICE, the entirety of which is hereby incorporated herein by reference.

### BACKGROUND

Input devices such as keyboards are often used with computers. Keyboards typically provide alpha-numeric inputs arranged in a familiar QWERTY pattern, and may include a number pad and/or function keys. Some keyboards include media buttons, volume controls, and/or quick launch buttons. In some cases the quick launch buttons may be assigned a user-specified functionality by opening a keyboard control program and associating a specific function with the quick launch button. One drawback with such an approach is that it is difficult for a user to ascertain the function of a user assignable key upon visual inspection, since the key itself is typically labeled with a non-descript label. In this case, the user relies upon his or her memory to recall the assigned function. Further, the position of these assignable keys is fixed, and the fixed position may not be suitable for the assignment of certain functions.

### SUMMARY

Various embodiments are disclosed that relate to the adjustment of an adaptive device in response to various computing system state changes such as system state changes, application state changes, user state changes, and adaptive device state changes. For example, one disclosed method provides receiving a system state input indicating a change in a system state of a computing device and changing adaptive device data in response to the system state input to form changed adaptive device data, where the adaptive device data and the changed adaptive device data each include one or more of image data and adaptive device mapping data. The method further includes adjusting an adaptive device display state using the changed adaptive device data, where adjusting the adaptive device display state includes one or more of displaying the image data on the keyboard display and adjusting an adaptive device mapping state according to the adaptive device mapping data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an environment for an example embodiment of an adaptive device.

FIG. 2 shows an example embodiment of adaptive input devices in the form of a mechanical keyboard and a virtual keyboard on a touch screen user input device.

FIG. 3 shows an example embodiment of adaptive input devices in the form of a mechanical keyboard and a virtual keyboard on a touch screen user input device, illustrating a change in a keyboard display and/or a keyboard mapping in response to a change in an adaptive device state, an application state, or a system state.

FIG. 4 shows a flow diagram depicting an embodiment of a method for adjusting an adaptive device based upon a system state change.

FIG. 5 shows a flow diagram depicting an embodiment of a method for adjusting an adaptive device based upon an application state change.

FIG. 6 shows a flow diagram depicting an embodiment of a method for adjusting an adaptive device based upon a device state change.

FIG. 7 shows another example embodiment of adaptive input devices in the form of a mechanical keyboard and a virtual keyboard on a touch screen user input device.

FIG. 8 shows an example embodiment of adaptive input devices in the form of a mechanical keyboard and a virtual keyboard on a touch screen user input device, illustrating a change in a keyboard display and/or a keyboard mapping in response to a change in an adaptive device state.

### DETAILED DESCRIPTION

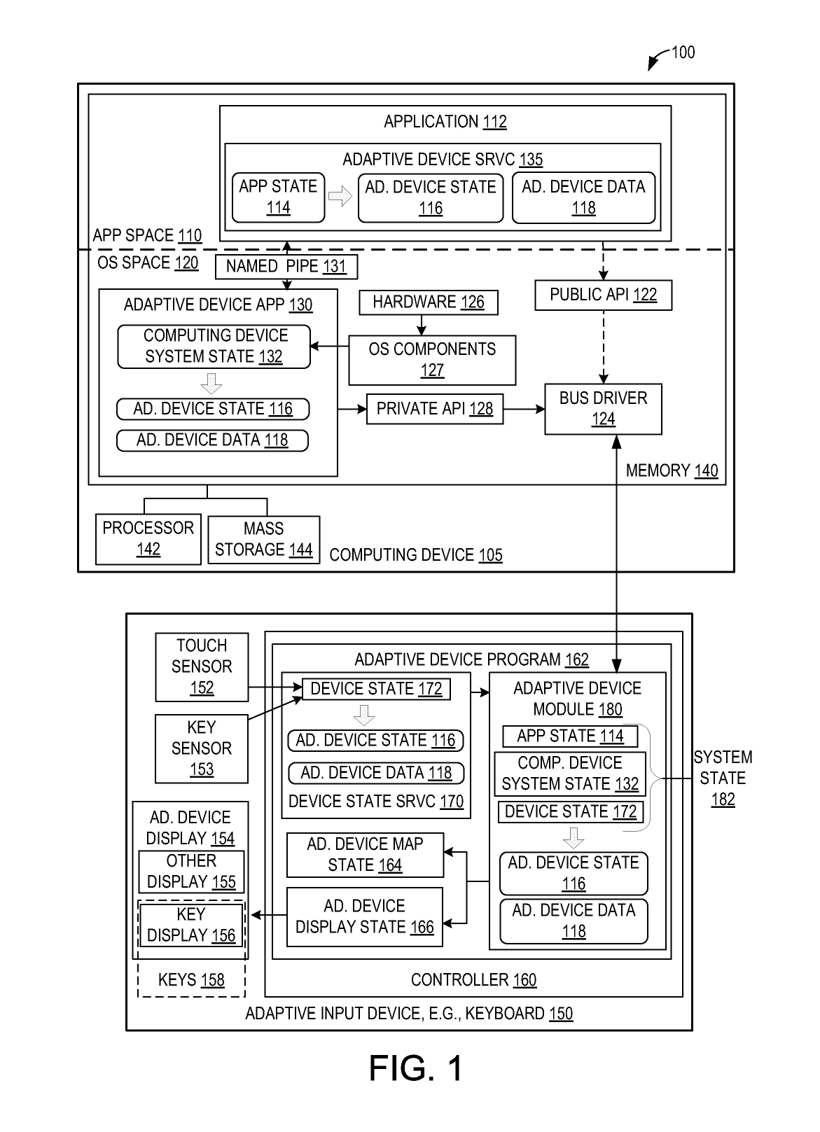

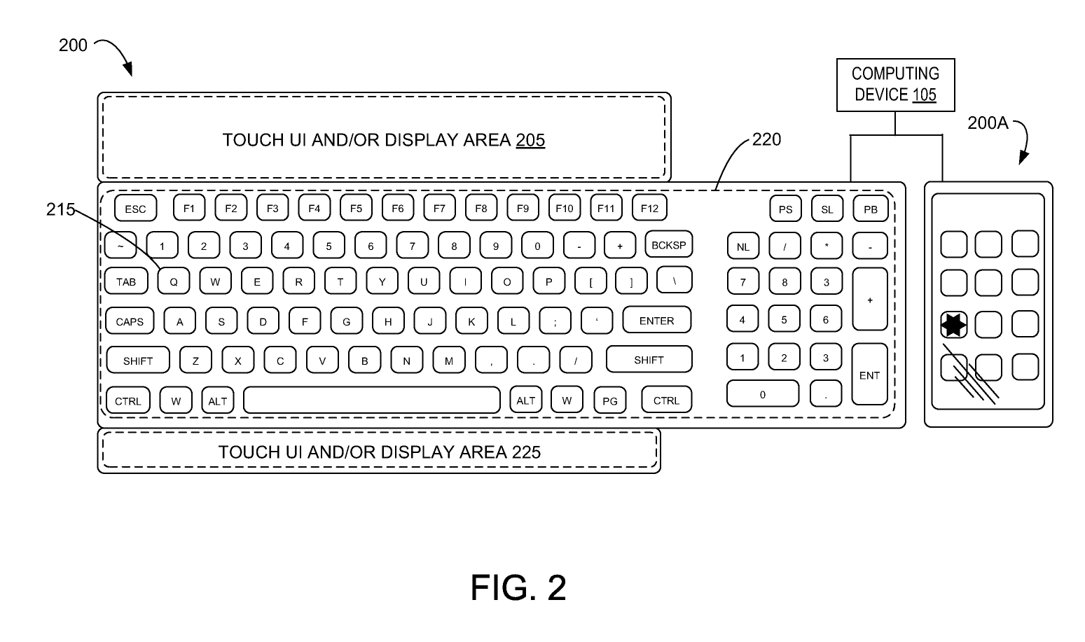

FIG. 1 shows an environment 100 for an example embodiment of an adaptive input device 150 (which also may be referred to herein as an “adaptive device”) that may adapt to computing device state changes such as system state changes, application state changes, and/or device state changes. Environment 100 includes a computing device 105 having a memory 140, a processor 142 and a mass storage 144. In some embodiments, mass storage 144 may comprise a hard drive, solid state memory, a rewritable disc, or any other suitable device. In the illustrated embodiment, memory 140 includes an operating system space 120 and an application space 110. Application space further includes an application 112 having an adaptive device application 130 containing an application state 114, and an associated adaptive device state 116 and adaptive device data 118. As discussed in detail below and illustrated in FIG. 2, in some embodiments, adaptive device 150 may comprise a mechanical keyboard 200 with mechanically depressible keys and/or other regions that are each configured to display an individually controllable image (e.g. via individually controllable screens on each key, across multiple keys, buttons, and/or other areas of the adaptive device, via a display located beneath the mechanical keyboard that is used to project images onto screens on each key, button, and/or other areas, or in any other suitable manner), or a virtual keyboard 200A displayed on a touch sensitive screen of an adaptive input device, for example. Other adaptive input devices are also contemplated, such as a mouse, remote, webcam, pen tablet, etc., which are equipped with displays and touch sensors, mechanical inputs, and/or other input actuators as described below. In general, the term “adaptive device” as used herein refers to an input device for a computing device that is configured to display visual content other than desktop content including those applications that are given system-wide active focus.

It will be understood that, in the description below, components shown to reside in OS space 120 also may be provided as runtime components residing on adaptive device 150, or in any other suitable location. Likewise, components and/or intelligence described as residing on adaptive device 150 also may reside on computing device 105, or in any other suitable location.

Returning to FIG. 1, in the illustrated embodiment, application 112 may communicate with adaptive device 150 via an interprocess communication mechanism, such as a named pipe 131 or COM API (component object model application programming interface), to an adaptive device application 130, which in turn communicates with adaptive device 150 through a mechanism such as a bus driver 124. Adaptive device application 130, may for example, be a service running on the operating system or a service running from a remote network location (e.g., via the web), and may interpret application specific events received via the named pipe 131 and in response send user interface messages to the adaptive device 150. Bus driver 124 may be configured to provide support for various transport protocols, such as Universal Serial Bus (USB), Transport Control Protocol over Internet Protocol (TCP/IP), Bluetooth, etc., and send the messages over a bus using one or more of these protocols to the adaptive device 150. Alternatively, the application 112 may communicate with the adaptive device 150 through an application programming interface, such as public application programming interface 122, and through bus driver 124.

Via either route, application 112 may send a message, an input, or other communication to the adaptive device 150, which message includes the application state 114, or the associated adaptive device state 116 or adaptive device data 118. However, other embodiments may not be so limited and the application state 114 may be mapped to adaptive device state 116 or adaptive device data 118 and otherwise communicated to adaptive device 150.

In operating system space 120, computing device 105 includes an adaptive device application 130 storing a computing device system state 132, an adaptive device state 116 and adaptive device data 118. Computing device system state 132 may receive input from operating system components 127 which may further receive inputs from hardware 126 of computing device 105 or attached devices. Adaptive device application 130 communicates with adaptive device 150 through a private application programming interface 128 and bus driver 124. For example, adaptive device application 130 may send a message, an input, or other communication to adaptive device 150 that includes the computing device system state 132, or the associated adaptive device state 116 or adaptive device data 118. However, other embodiments may not be so limited and the computing device system state 132 may be mapped to adaptive device state 116 or adaptive device data 118 and otherwise communicated to adaptive device 150.

Continuing with FIG. 1, adaptive device 150 includes a controller 160 coupled with a plurality of keys 158, one or more of which are configured to display an individually controllable image via an adaptive device display 154, and also includes an adaptive device program 162. In some embodiments adaptive device 150 may include a touch sensor 152 to detect a touch input made via the adaptive device 152, and key sensors 153 configured to detect inputs such as, for example, keyboard keystrokes in an adaptive keyboard device. Touch sensor 152 may comprise an optical touch sensor configured to optically detect a user touch of a region of the keyboard, a capacitive touch sensor configured to detect an electrical change from a touch by a user, a resistive touch sensor configured to resistively detect a user touch, or any other suitable touch sensor. Likewise, key sensors 153 may comprise any suitable mechanism for detecting a keyboard keystroke. It will be understood that, in some embodiments, the logic described herein that is performed via adaptive device program 162 may instead reside on computing device 105, or in any other suitable location.

As mentioned above, adaptive device 150 include a keys display 156 on one or more of the keys 158, and/or a display 155 on a body of the keyboard, projected from the keyboard, attached to the keyboard, etc. Additionally, adaptive device display 154 also may include a plurality of displays, wherein adaptive device program 162 may update each of the plurality of displays according to respective system state changes, application state changes, and device state changes.

Adaptive device 150 sends and receives communications from computing device 105 through bus driver 124 in the computing device. Adaptive device program 162 further includes an adaptive device module 180, an adaptive device mapping state 164, an adaptive device display state 166 and a device state service 170. Device state service 170 further includes a device state 172 as sensed by touch sensor 152 and/or key sensors 153, and an associated adaptive device state 116 and adaptive device data 118.

Adaptive device module 180 includes one or more inputs indicating a change of state 182, which may include one or more of the application state 114, the computing device system state 132 and/or the device state 172. Alternately, adaptive device module 180 may receive an already associated adaptive device state 116 and/or adaptive device data 118, wherein the adaptive device state 116 and adaptive device data is associated with a system state by the adaptive device application 130 running in the application space 110 or operating system space 120, as non-limiting examples.

As mentioned above, adaptive device 150 may be configured to receive a state input indicating a change in a system state, application state, user state, and/or device state, and change adaptive device data 118 in response to the state input. For example, the adaptive device data 118 may include one or more of image data or adaptive device mapping data, and the controller may be configured to adjust the adaptive device display using the image data and further configured to adjust a keyboard mapping state according to the adaptive device mapping data. Image data may comprise keyboard legends, icons, menu items or other data from application 112, operating system components 127, configuration options for hardware 126, etc.

In some examples, image data that may be displayed on one or more keys may be provided by application 112 running on the computing device 105, by an operating system of the computing device 105, saved in memory on the adaptive device 150, etc. For example, to display image data on a specific key or to a specific display portion on the keyboard, the adaptive device program 162 may receive adaptive device state 116 from the adaptive device application 130 running in the application 112, system state operating system space 120 on computing device 105, or from the device state service 170 on the adaptive device 150, as will be explained in the following paragraphs in more detail.

In one example embodiment, the state change may be a change in application state 114 in computing device 105 in communication with the adaptive device 150. For example, the adaptive device 150 may be configured to receive the change in the application state 114 through a public application programming interface 122 and to adjust the adaptive device display 154 based upon the change in application state 114. Various example embodiments of such application state changes and adjustments to adaptive device 150 are described in more detail below.

In some embodiments, a change in application state 114 may be determined based on if the application 112 is an active application, whether the application 112 is operating in the computing background, whether there are different states within the application while the application 112 is active, etc. In one example, if text is selected in a word processing program, a change in application state 114 may be detected. In response to the change in application state 114, functionality available to manipulate the selected text may be displayed and exposed to a user of the keyboard through adaptive device display 154, key mapping, etc.

As a more specific example, in one embodiment, if a user in the word processing application had previously selected text and changed the text to blue text, the change in application state 114 may be detected when the text is selected, and an adaptive device display may show multiple selectable colors to which the user may change the text. In a particular example, such previous actions of the user may be ranked according to frequency, a recent change, in relation to the change in application state 114, etc. Then, the adaptive device display 154 may present a list of options for the user to select. In this way, if the user most recently selected text and converted the text to blue text, but had previously selected the text and converted it to red text, a first option may be displayed of converting the text to blue text, a second option may be displayed to convert the text to red text, etc.

In another example change in application state 114, when a slide show presentation program is first launched, there may be a state where the program queries a user if they are creating a new slide show or if the user wants to open a recent slide show. If a user selects to open a recent slide show, the adaptive device program 162 may detect this change in application state 114 and change the adaptive device display 154 to show, for example, the ten most recent slide show presentations that have been opened. Furthermore, once a slide show is selected, the adaptive device program 162 could detect another state change and display on the adaptive device display 154 options within the opened slide show. For example, as a user navigates the opened slide show, or as a user selects an animation to include in the slide show, functionality associated with the navigation or the animation may be exposed to the user through the adaptive device display 154 and the user could select the functionality through the keyboard without keystroke sequences that take the user into the menu options.

In another example embodiment, the change in system state may be a change in a computing device system state 132 in communication with the adaptive device 150. For example, the keyboard may be configured to receive the change in the computing device system state 132 through a private application programming interface 128 and may be further configured to display on the adaptive device display 154 user options related to the change in computing device system state 132. For example, a change in a computing device system state 132 may include a computer turning on, turning off, going to sleep, being placed in a standby state, turning on a screen saver, as non-limiting examples. In this way, a detectable change in a computing device system state 132 may be displayed to a user through adaptive device display 154 using adaptive device program 162.

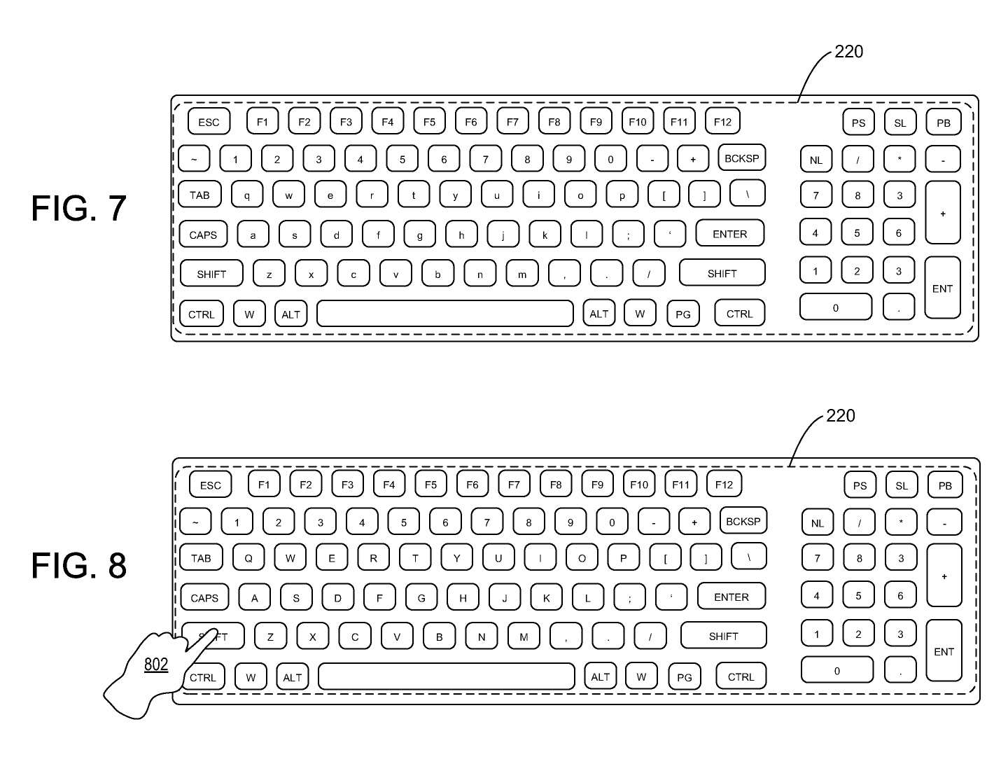

In some embodiments, a change in state may comprise a change in device state 172 (i.e., adaptive device state) detected by touch sensor 152, key sensors 153, and/or other suitable sensors (e.g., accelerometers, proximity sensors, etc. included on the keyboard). For example, a change in device state 172 may comprise a change in a user-related device state. Such a change in a device state may be detected when a user touches the keyboard, when a keyboard is moved or picked up, when a user is approaching a keyboard, when a user presses one or more keys or a key sequence, when a user introduces another device into the system, when a user evokes a mode on another device connected to the system, etc. Other device state changes 172 may be detected, for example, when a user selects a key on the keyboard that changes a keyboard state (e.g., a “shift” key or other such toggle key that toggles between states), interacts with an interactive display on the keyboard that is displaying one or more user options, etc. In this way, when a device state changes, the adaptive device 150 may be configured to change a display state in response to the user state change. As an example, FIG. 7 shows a keyboard on which the legends on the letter keys are displayed as lowercase letters. When user 802 selects the shift key, as shown in FIG. 8, the display changes to show the legends as uppercase letters.

In some embodiments, the adaptive device 150 may be configured to change the adaptive device mapping state 164 of the plurality of keys 158 in response to an input indicating a change in application state 114, adaptive device state 116, or computing device system state 132. In some examples, the application state may be multiple applications/services working together for a particular activity. As an example, adaptive device program 162 may comprise a look up table (LUT) configured to map a key code from application 112 to a particular key and provide the key code in response to a subsequent push of the key. In a game application example, a “Q” button press on a keyboard may fire a weapon within the game. The adaptive device program 162 may then be configured to communicate with the game application, map one or more key codes from the game application to respective keys, and in response to a button press on a mapped key, in this example a “Q”, the adaptive device program 162 may send to the game the respective codes, in this example the key code for firing the weapon.

In some embodiments, adaptive device program 162 may adjust an adaptive device display or an adaptive device mapping state (e.g. a keyboard mapping state in an adaptive keyboard) in response to a combination of state changes. For example, a change in user state can be detected when a user approaches the adaptive device 150 while an attached computing device is in a locked state. In this way, the adaptive device program can illuminate keyboard keys 158 when the user gets within range and also display instructions to the user to type in a password to unlock the computing device.

FIG. 2 shows an example embodiment of an adaptive device in the form of a mechanical keyboard 200, with keyboard display 220 and example other displays 205, 225 shown as an example of the adaptive device display 154 of FIG. 1. The adaptive device display 220 is indicated schematically via a dashed line around the keys of the keyboard, which signifies that, in various embodiments, individually controllable images may be displayed on each key and/or in regions between, around and/or otherwise adjacent to the keys.

The adaptive device display and other displays may each be configured to provide input and output functionality. For example, the other displays may be configured to receive touch inputs as well as to provide image outputs. Likewise, the adaptive device display, in addition to providing image outputs and receive mechanical key press inputs, also may be configured to accept touch inputs. Example embodiments utilizing optical touch screens are described in more detail below.

Keyboard 200 comprises a plurality of keys including example key Q 215 in the key mapping embodiment as described above with reference to FIG. 1. FIG. 2 also illustrates a virtual keyboard 200A of a touch screen user input device. The touch screen user input device is configured with a keyboard display and touch sensor configured to receive touch input from a user. The virtual keyboard 200A may include keys of various sizes and shapes that are displayed on the touch screen user input device, as illustrated. In one example key, a star is depicted.

Any suitable mechanism may be used to display images on keyboard display 200 and other displays 205, 225. For example, in some embodiments, a separately controlled display panel (LCD, OLED (organic light-emitting device), etc.) may be located on each keyboard key and each of the other displays. In other embodiments, each keyboard key and each of the other displays may comprise a diffusing screen configured to display an image produced by one or more display panels (LCD or other) located beneath the keyboard keys and other displays. In yet other embodiments, each keyboard key and each of the other displays may comprise a transparent, clear window through which an underlying display may be viewed. Such a window on a keyboard key may include a clear optical pillar extending downwardly from the window toward the underlying display to move an image plane of the optical system closer to the surface of the key. In yet other embodiments, an image from a display mechanism such as a digital micromirror device (DMD) or other microdisplay may be projected onto the keyboard keys and/or other displays via optics such as an optical wedge,

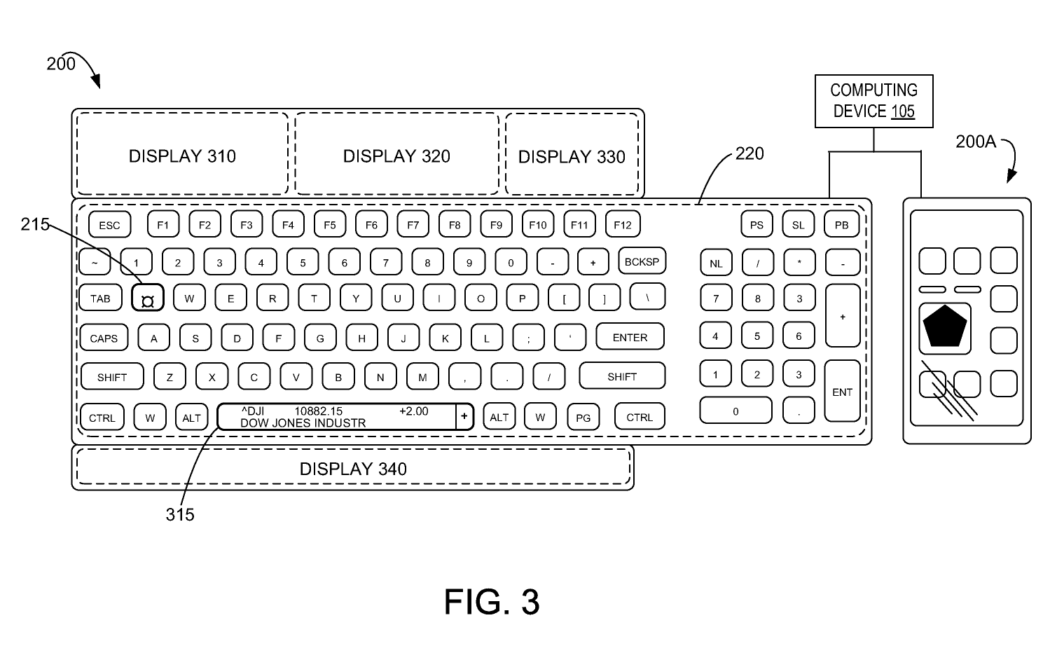

FIG. 3 shows an example embodiment of a keyboard 200 illustrating a change in a keyboard display and/or a keyboard mapping in response to a change in a computing device system state, a device state, or an application state. FIG. 3 illustrates keyboard 200 after a system state change with a different image displayed on display 215 shown on the previous “Q” button. In some embodiments the button will be mapped to a specified functionality, such as the weapon firing example in FIG. 1 as described above. FIG. 3 also illustrates keyboard 200A showing a key formed in a different size and shape, and with a different image, namely a pentagon, depicted thereon, as compared with the star of the previous figure, in response to a device, system, or application state change.

FIG. 3 further illustrates display 310, display 320, display 330, display 340, and keyboard display 220 as example embodiments of adaptive device display 154 from FIG. 1. It is to be understood that although a keyboard is shown in the examples of FIGS. 2 and 3, the adaptive device may be any suitable device with an interactive display such as a mouse, remote, webcam, pen tablet, etc.

In some embodiments, adaptive device display 154 and other display 155 may be controlled by adaptive device module 180 running in adaptive device program 162 on controller 160. In this way, adaptive device module 180 may display image data and/or other content provided by computing device 105, application 112, by a user input, in response to a change in device state 172, or otherwise as stored on an attached computing device 105 or resident in memory on the keyboard. Further, a plurality of application programs may be configured to output display data to different regions of the keyboard concurrently, thereby sharing the composite keyboard display. As another example, application programs may be configured to cascade or distribute portions of their output display data across multiple adaptive input devices.

In an example use case scenario, display 310 may display a standby computing device system state 132 as received from computing device 105 through a private application programming interface 128 and a bus driver 124. Then, display 310 may prompt a user for a password to unlock the computing device 105 if it is locked, as an example. As another example use case scenario, once the computer is unlocked, the display 320 may provide menu options for media player application as received through public application programming interface 122 and bus driver 124. In this way, display 320 may display the menu options for the media player for recently played audio files in response to sensing a user approaching the keyboard.

In some embodiments, the display may include regions not indicated in FIGS. 2 and 3. For example, in some embodiments, a display may be located under the keys of the keyboard such that display images can be projected onto screens on each key and/or in the areas between and/or around the keys, to the right and/or left edges of the keyset, etc. Further, in some embodiments, the touch area may be across the mechanical keys, and mechanical keys may further be located in display areas 205, 220, and 225, for example. As a more specific example, an image sensor may be used to optically detect touch on the key of each screen, for example, by delivering an image of the keyboard keys to a camera via wedge optics, by using an image-sensor-in-pixel display panel to display images on the keyboard, or in any other suitable manner. Likewise, capacitive, resistive, or any other suitable mechanism may be used to detect touch inputs on keys and/or other display areas.

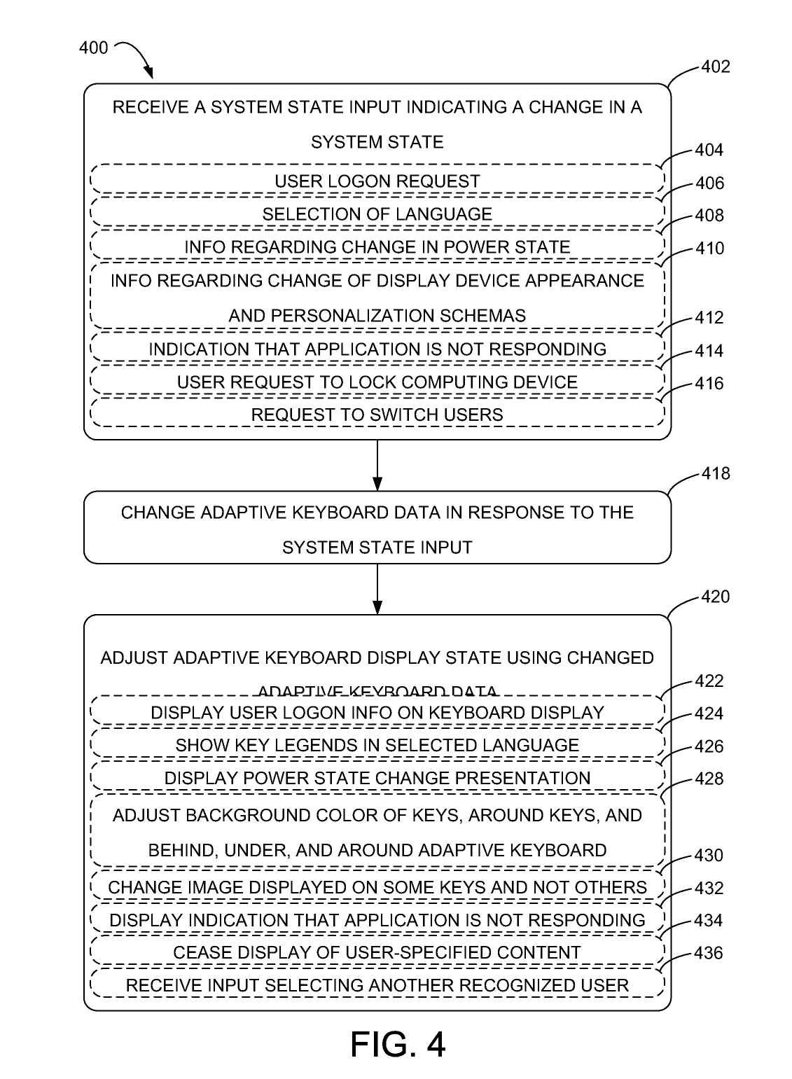

Continuing with the FIGS. 4-6 show flow diagrams illustrating various example embodiments of methods for adjusting an adaptive device in response to computing device system state changes, application state changes, and adaptive device state changes. The flow diagrams in FIGS. 4-6 refer to embodiments in which a keyboard is the adaptive device; however, it is to be understood the adaptive device may be any other suitable adaptive device including but not limited to a mouse, remote, webcam, pen tablet, etc.

First, FIG. 4 shows a flow diagram of an embodiment of a method for a computing device system state change for an adaptive device. First, as indicated at 402, method 400 comprises receiving a system state input indicating a change in a system state. Next, at 418, method 400 comprises changing adaptive device data in response to the system state input to form changed adaptive device data. As described above, the adaptive device data and the changed adaptive device data may each include one or more of image data and adaptive device mapping data, for example. Then, at 420, method 400 comprises adjusting an adaptive device display state using the changed adaptive device data. Adjusting the adaptive device display state may include, for example, one or more of displaying the image data on the keyboard display and adjusting an adaptive device mapping state according to the adaptive device mapping data.

Any suitable system state change may be received, and the adaptive device display state may be adjusted in any suitable manner in response. In one example embodiment, receiving a change in a system state includes receiving a user logon request at 404, and adjusting the adaptive device display state includes displaying user logon information on the keyboard display at 422. In this manner, logon information may appear on the keyboard display instead of on a monitor or other display device connected to the computing device. This may help to maintain such information private from other persons who are nearby during user login.

In another example embodiment, receiving a change in system state includes receiving a selection of a language in which to display keyboard characters at 406, and adjusting the adaptive device display state includes adjusting the keyboard display to show key legends in the language selected at 424. Such a method may further include updating firmware on the adaptive device to store in the firmware the legends in the language selected. As such, the display language changes so that an accurate localized legend is available during a boot process of the computing device and adaptive device.

In another example embodiment, receiving a change in system state includes receiving information regarding a change in a power state of the computing device at 408, and adjusting the adaptive device display state includes displaying via the adaptive device display a power state change presentation at 426 in response to the power state change. For example, legends displayed on the keys may fade-in/fade-out when power comes/goes, or the adaptive device may display any other suitable transition.

In still another example embodiment, receiving a change in system state includes receiving information regarding a change of display device appearance and personalization schemas displayed on a display device at 410, and adjusting the adaptive device display state includes adjusting a background color of keys of the adaptive device at 428. For example, a screen saver mode of a display device connected to the computing device may be reflected on the adaptive device through ambient back light/background on one or more of keys, a space around one or more keys, a space behind the adaptive device, a space under the adaptive device, and a space around the adaptive device. As another example, extended ambience on keys may be based on a display device color palette.

In still another example embodiment, adjusting the adaptive device display state includes changing an image displayed on some keys of the adaptive device while not changing an image displayed on other keys of the adaptive device at 430 of method 400. For example, the adaptive device may comprise persistent viewable regions (PVRs) which are virtual/real keys that have persistent visual appearance and function regardless of application context. Such keys can activate, launch, and control things that are not directly related to an application in focus but also be used to change application environment, etc. For example, the keys may launch a website associated with a game, present a flick control to move between sub-windows, or the keys may be music/video trick controls (play, stop, pause, fwd, etc.).

As another example embodiment, receiving a change in system state includes receiving an indication that an application running on the computing device is not responding at 412, and adjusting the adaptive device display state comprises displaying on the adaptive device an indication that the application is not responding at 432. For example, if an application is not responding, the adaptive device reflects any functions that cannot be used, e.g., by decreasing a brightness of keys representing those functions, by changing an image on such keys, etc. As another example, when the operating system dims the application because it is not responding, the corresponding keyboard content displayed on the adaptive device also dims. In another example, the system itself may not be responding and the adaptive device display is adjusted to indicate the system is not responding. Further, the adaptive device display may be adjusted to indicate any type of error conduction, assistive help, troubleshooting, etc.

In still another example embodiment, receiving a change in system state includes receiving a user request to lock the computing device at 414, and adjusting the adaptive device display state includes ceasing displaying user-specified content while the computing device is locked at 434. As such, content displayed on the keyboard may change based on privacy settings, such that private information is not shown when in the locked state, whereas public information may be shown when in the locked state.

In a further example embodiment, receiving a change in system state includes receiving a request to switch users of the computing device via an interactive list of recognized users displayed on the keyboard display at 416. In this example, adjusting the adaptive device display state includes receiving an input selecting another recognized user via the interactive display of recognized users on the keyboard display at 436, and then adjusting the keyboard display state to display the adaptive device according to the new user's preferences, e.g., as stored in a user profile. Such an embodiment may enable fast user switching, as user sessions may be switched without logging off a main screen of the display device for the current user.

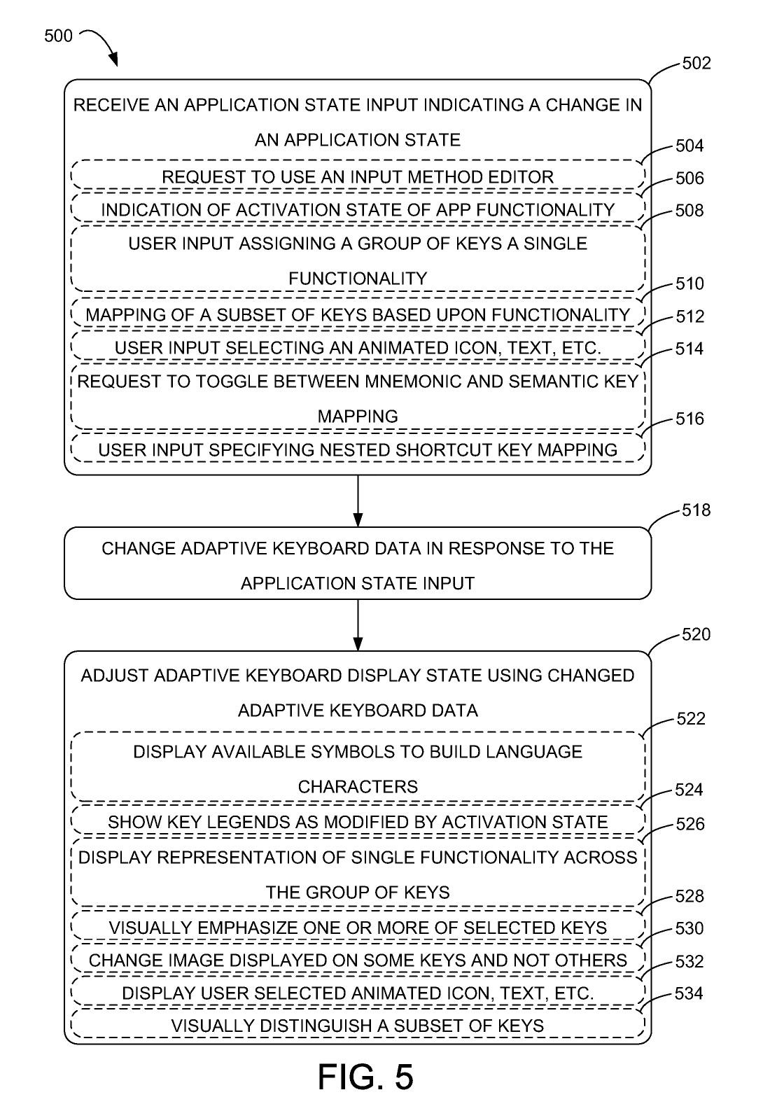

FIG. 5 shows a flow diagram of an embodiment of a method for adjusting an adaptive device display state based upon a state change of an application running on a computing device to which the adaptive device is connected. First, as indicated at 502, method 500 comprises receiving an application state input indicating a change in an application state. Next, at 518, method 500 comprises changing adaptive device data in response to the application state input to form changed adaptive device data. The changed adaptive device data may include one or more of image data and adaptive device mapping data, for example, as described above. Then, at 520, method 500 comprises adjusting an adaptive device display state using the changed adaptive device data. Adjusting the adaptive device display state may include, for example, one or more of displaying the image data on the adaptive device display or adjusting an adaptive device mapping state according to the adaptive device mapping data.

In one example embodiment, receiving a change in application state includes receiving a request to use an input method editor at 504, and adjusting the adaptive device display state includes adjusting the adaptive device display by displaying on key displays or other adaptive device displays available symbols to build language characters at 522. For example, a user can build a language character using symbol building blocks that appear on keys. Further, in some embodiments, building blocks for characters may appear on keys via heuristics as the input language editor detects character inputs. In this manner, only building blocks relevant to a character currently being assembled may be displayed, and may be updated as building blocks are added. Further, composition string options may be shown on the keyboard keys or touch display affordance allowing user to pick the right string to send to a word processing application without glancing away from the keys.

In another example embodiment, receiving a change in application state includes receiving an indication of an activation state of an application functionality at 506, and adjusting the adaptive device display state includes displaying a representation of the activation state on the adaptive device, for example, by showing key legends as modified by the activation state at 524. As a more specific example, upon selection of a key that toggles an application functionality, the keyboard keys may update to show activation/toggle state. Thus, when a user selects a toggle key such as italics, bold, underline, etc., or keys that together composite a mode (e.g., italics+bold shortcut keys or calculator hotkey+scientific shortcut key), the legends keys of the adaptive device may show the current state visually such that all relevant characters are shown in the toggled or composite state.

In yet another example embodiment, receiving a change in application state includes receiving user input assigning a group of keys a single functionality at 508, and adjusting the adaptive device display state includes displaying a representation of the single functionality across the group of keys at 524. This may allow applications or users to create a graphical representation of a relevant command that spans multiple close proximity input affordances, thereby making the keys that represent the command easier to see and activate. As a more specific example, each of the three rows of letter keys in a virtual or tactile keyboard may be illuminated in a single color, and/or a graphic spanning all keys in each row may indicate one of three tiers of interaction with a particular application feature.

In another example embodiment, receiving a change in application state includes receiving a mapping of a subset of keys of the adaptive device based upon a functionality specific to a state of the application, and adjusting the adaptive device display state includes visually emphasizing the subset of keys compared to the other keys at 526. For example, a brightness of the legend on keys that are currently “hot keys” may be increased relative with respect to other keys. Such a subset of keys may be, for example, a group of keys that behave as a “radio button group” such that when one is activated the rest deactivate, and the state represented may affect the rest of the keyboard (e.g., the F-row keys may represent selectable tabs and the selected tab is reflected in the current application). As another example, when using the ALT key in combination with other keys (“accelerator keys”) as shortcut keys, the accelerator keys relevant in the current application may be visually distinguished on the keyboard from other keys (e.g., via brightness, color, legend, or in any other suitable manner).

In another example embodiment, adjusting the adaptive device display state may include changing an image displayed on some keys of the adaptive device while not changing an image displayed on other keys of the adaptive device when a user changes applications running on the computing device at 528. For example, in one specific example, zoom controls on an adaptive device may always be available regardless of a currently active application, while other controls change contextually as application state changes.

In yet another example embodiment, receiving a change in application state includes receiving a user input selecting an animated icon, text, or graphical gadget at 512, and adjusting the adaptive device display includes displaying the user selected animated icon, text, or graphical gadget on a selected region of the display of the adaptive device at 532. For example, in one specific example of such a gadget, the system may display a rolling stock ticker on the tactile or virtual space bar of the adaptive device, as shown at 315 in FIG. 3.

In a further example embodiment, receiving a change in application state includes receiving a user input comprising a request to toggle between a mnemonic key mapping and a semantic key mapping at 514. The term “mnemonic key mapping” refers to key placement by region such that the mapping is sensed by hand placement, whereas the term “semantic key mapping” refers to placement by letter association.

In still another example embodiment, receiving a change in application state includes receiving a user input comprising a specified nested shortcut key mapping for a plurality of shortcut keys at 516, and adjusting the adaptive device display state includes visually distinguishing a subset of keys mapped to functionalities in a next-lowest hierarchical level from other keys not mapped to functionalities in the next-lowest hierarchical level when a user selects a shortcut key within a hierarchical level at 534. As such, each input device affordance can show the user a recognizable glyph that leads the user to the next level in the command/control structure on the virtual or tactile keys of the adaptive device.

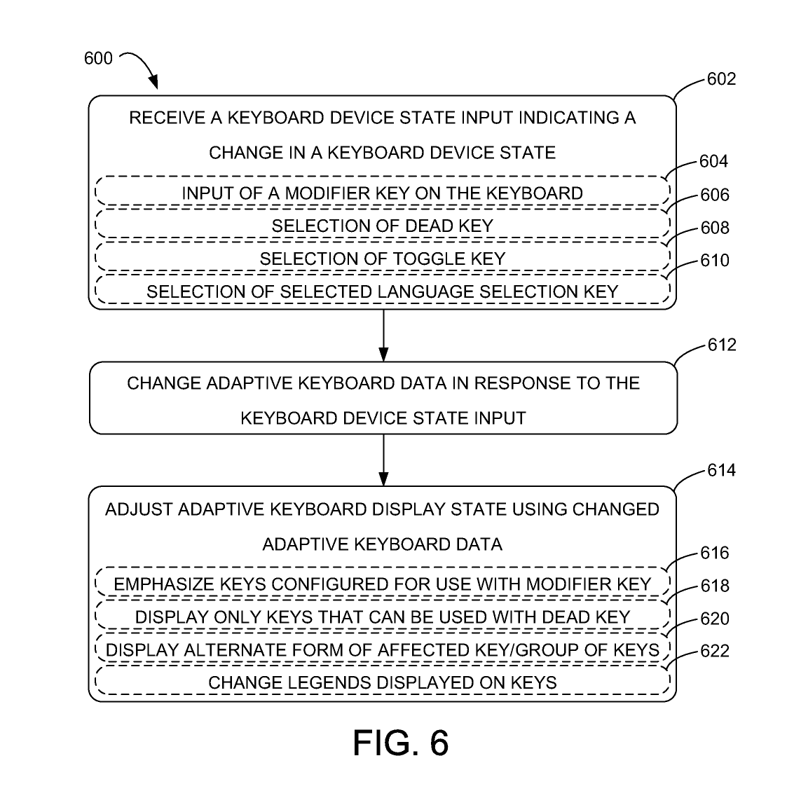

FIG. 6 shows a flow diagram of an embodiment of a method for adjusting a display state of an adaptive device based upon an adaptive device state change. First, as indicated at 602, method 600 comprises receiving an adaptive device state input indicating a change in an adaptive device state. Next, at 612, method 600 comprises changing adaptive device data in response to the adaptive device state input to form changed adaptive device data. The adaptive device data and changed adaptive device data may include one or more of image data and keyboard mapping data, for example.

Then, at 624, method 600 comprises adjusting the adaptive device display using the changed adaptive device data. Adjusting the adaptive device display state may include, for example, one or more of displaying the image data on the adaptive device display or adjusting an adaptive device mapping state according to the adaptive device mapping data, as described above.

In one example embodiment, receiving a change in adaptive device state includes receiving an input of a modifier key on the keyboard at 604, and adjusting the adaptive device display includes visually emphasizing keys configured to be used in conjunction with the modifier key compared to keys not configured to be used with the modifier key at 616. For example, legends such as modifier-enabled and dead-key enabled legends may be automatically synchronized with operating system settings and modifier key states.

As a more specific example, when a dead key is selected at 606, the keyboard display state is adjusted to display only keys that can be augmented with a symbol represented by the dead key at 618.

In another example embodiment, receiving a change in adaptive device state includes receiving selection of a toggle key at 608, and adjusting the adaptive device display state includes displaying an alternate form of an affected key or group of keys at 620. For example, where the toggle key is a Shift key, all affected keys (e.g., all letter and number keys) show capitalized letters/symbols when Shift is selected. As another example, where the toggle key is the Caps Lock key, all letter keys show capitalized letters when Caps Lock is selected.

In still another example embodiment, receiving a change in adaptive device state includes receiving selection of a language selection control displayed on the keyboard (e.g., on key or in touch region) at 610, and adjusting the adaptive device display state includes changing an input language of the adaptive device based upon the selected language by changing legends displayed on the keys of the adaptive device at 622. For example, display 330 in FIG. 3 may be a touch display that shows available languages that may be selected. As such, a user may easily switch between multiple input languages quickly.

It will be appreciated that the embodiments described herein may be implemented, for example, via computer-executable instructions or code, such as programs, stored on a computer-readable storage medium, such as a DVD (digital versatile disc), CD (compact disc), flash memory drive, floppy disk, etc., and executed by a computing device. Generally, programs include routines, objects, components, data structures, and the like that perform particular tasks or implement particular abstract data types. As used herein, the term “program” may connote a single program or multiple programs acting in concert, and may be used to denote applications, services, or any other type or class of program. Likewise, the terms “computer” and “computing device” as used herein include any device that electronically executes one or more programs, including, but not limited to, a keyboard with computing functionality and other computer input devices.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description.

The subject matter of the present disclosure includes all novel and nonobvious combinations and subcombinations of the various processes, systems and configurations, and other features, functions, acts, and/or properties disclosed herein, as well as any and all equivalents thereof.

1. In an adaptive input device configured to display changeable images on an adaptive input device display disposed on one or more of a body and one or more input actuators of the adaptive input device, a method of adapting one or more of an adaptive input device mapping and an image displayed on the adaptive input device display in response to a system state change in a computing device in communication with the adaptive input device, the method comprising:
receiving a system state input indicating a change in a system state of the computing device;
changing adaptive input device data in response to the system state input to form changed adaptive input device data, the adaptive input device data and the changed adaptive input device data each including one or more of image data and adaptive input device input mapping data; and
adjusting an adaptive input device display state using the changed adaptive input device data, wherein adjusting the adaptive input device display state includes one or more of displaying the image data on the adaptive input device display and adjusting an adaptive input device mapping state according to the adaptive input device input mapping data.

2. The method of claim 1, wherein receiving the system state input comprises receiving a user logon request, and wherein adjusting the adaptive input device display state comprises displaying user log-on information on the keyboard display.

3. The method of claim 1, wherein receiving the system state input comprises receiving a selection of a language in which to display keyboard characters, wherein adjusting the adaptive input device display state comprises adjusting the keyboard display to show key legends in the language selected, and wherein the method further comprises updating firmware on the adaptive input device to store in the firmware the legends in the language selected.

4. The method of claim 1, wherein receiving the system state change comprises receiving information regarding a change in power state of the computing device, and wherein adjusting the adaptive input device display state comprises displaying a power state change presentation.

5. The method of claim 1, wherein receiving the system state change comprises receiving information regarding a change of change of display device appearance and personalization schemas displayed on a display device, and wherein adjusting the adaptive input device display state comprises adjusting a background color of one or more of keys, a space around one or more keys, a space behind the adaptive input device, a space under the adaptive input device, and a space around the adaptive input device.

6. The method of claim 1, wherein receiving the system state change comprises receiving an indication that an application running on the computing device is not responding, and wherein adjusting the adaptive input device display state comprises displaying on the adaptive input device display an indication that the application is not responding.

7. The method of claim 1, wherein receiving the system state change comprises receiving a user request to lock the computing device, and wherein adjusting the adaptive input device display state comprises ceasing displaying user-specified content while the computing device is locked.

8. The method of claim 1, wherein receiving the state change comprises receiving a request to switch users of the computing device via an interactive display of recognized users on the keyboard display, and wherein adjusting the adaptive input device display state includes receiving an input selecting another recognized user via the interactive display of recognized users on the keyboard display.

9. A computer-readable medium comprising instructions executable by a computing device to adapt an image displayed on a display of an adaptive keyboard in response to a change of state of a computer-executable application, the instructions being executable to:
receive an application state input indicating a change in an application state;
change adaptive keyboard data in response to the application state input to form changed adaptive keyboard data, the changed adaptive keyboard data including one or more of image data and adaptive keyboard mapping data; and
adjust an adaptive keyboard display state using the changed adaptive keyboard data, wherein adjusting the adaptive keyboard display state includes one or more of displaying the image data on the adaptive keyboard display and adjusting an adaptive keyboard mapping state according to the adaptive keyboard mapping data.

10. The computer-readable medium of claim 9, wherein the instructions are executable to receive the application state input by receiving a request to use an input method editor, and to adjust the adaptive keyboard display by displaying available symbols to build language characters.

11. The computer-readable medium of claim 9, wherein the instructions are executable to receive the application state input by receiving an indication of an activation state of an application functionality, and to adjust the adaptive keyboard display state by displaying a representation of the activation state on the adaptive keyboard by showing key legends as modified by the activation state.

12. The computer-readable medium of claim 9, wherein the instructions are executable to receive the application state input by receiving user input assigning a group of keys a single functionality, and to adjust the adaptive keyboard display state by modifying a display of the group of keys to illustrate the single functionality by displaying a representation of the single functionality across the group of keys.

13. The computer-readable medium of claim 9, wherein the instructions are executable to receive the application state input by receiving a mapping of a subset of keys of the adaptive keyboard based upon a functionality specific to the state of the application after the state change, and to adjust an adaptive keyboard display state by visually emphasizing the subset of keys compared to other keys.

14. The computer-readable medium of claim 9, wherein the instructions are executable to receive the application state input by receiving a user input selecting an animated icon, text, or graphical gadget, and to adjust the adaptive keyboard display state by displaying the user selected animated icon, text, or graphical gadget on a selected region of the display of the adaptive keyboard.

15. The computer-readable medium of claim 9, wherein the instructions are executable to receive the application state input by receiving a user input comprising a request to toggle between a mnemonic key mapping and a semantic key mapping.

16. The computer-readable medium of claim 9, wherein the instructions are executable to receive the application state input by receiving a user input comprising a specified nested shortcut key mapping for a plurality of shortcut keys, and to adjust the adaptive keyboard display state by visually distinguishing a subset of keys mapped to functionalities in a next-lowest hierarchical level from other keys not mapped to functionalities in the next-lowest hierarchical level when a user selects a shortcut key within a hierarchical level.

17. An adaptive keyboard, comprising:
a plurality of keys each configured to display an individually controllable image; and
a controller in communication with the plurality of keys and including an adaptive keyboard program, the adaptive keyboard program configured to receive a keyboard device state input indicating an occurrence of a change of keyboard device state, and to change adaptive keyboard data in response to the keyboard device state input to form changed adaptive keyboard data, the adaptive keyboard data and changed adaptive keyboard data each including one or more of image data and keyboard mapping data, wherein the controller is configured to adjust the keyboard display using the image data and further configured to adjust a keyboard mapping state according to the keyboard mapping data.

18. The adaptive keyboard of claim 17, wherein the controller is configured to receive the keyboard device state input by receiving an input of a modifier key on the keyboard, and to adjust the keyboard display by visually emphasizing keys configured to be used in conjunction with the modifier key compared to keys not configured to be used with the modifier key.

19. The adaptive keyboard of claim 18, wherein the modifier key is a dead key, and wherein, in response to selection of the dead key, the controller adjusts the keyboard display to display only keys that can be augmented with a symbol of the dead key.

20. The adaptive keyboard of claim 18, wherein the modifier key is a toggle key, and wherein, in response to selection of the toggle key, the controller adjusts the keyboard display such that an alternate form of an affected key is displayed.
